(19) United States
(12) Patent Application Publication
(10) Pub. No.: US 2014/0319746 A1
(43) Pub. Date: Oct. 30, 2014

(54) MACHINE TOOL

(71) Applicant: MURATA MACHINERY, LTD., Kyoto-shi, Kyoto (JP)

(72) Inventor: Haruaki Kozawa, Inuyama-shi (JP)

(21) Appl. No.: 14/366,008

(22) PCT Filed: Nov. 26, 2012
(86) PCT No.: PCT/JP2012/080429

§ 371 Date: Jun. 17, 2014

(30) Foreign Application Priority Data
Dec. 22, 2011 (JP) 2011-281062

(51) Int. Cl. B23Q 3/10; B23Q 1/03

(52) U.S. Cl. CPC B23Q 3/10; B23Q 1/03
USPC 269/14

(57) ABSTRACT

A machine tool includes a machine bed, a processing machine mounted on the machine bed to perform mechanical processing on a workpiece, a covering unit configured to enclose a processing station, and a shroud support member configured to support the covering unit in a non-contact relation with the machine bed. The machine tool also includes a loader configured to travel along a rail while holding the workpiece, and configured to selectively load and unload the workpiece relative to the processing machine.

This application is based on and claims Convention priority to Japanese patent application No. 2011-281062, filed Dec. 22, 2011, the entire disclosure of which is herein incorporated by reference as a part of this application.

### BACKGROUND OF THE INVENTION

1. Field of the Invention

The present invention relates to a machine tool such as, for example, a lathe and, more particularly, to a structure of a covering included in such machine tool that is configured to prevent processing from being affected by vibrations from inside and outside of a machine.

2. Description of the Related Art

In the conventional machine tool, a shroud or covering support member 6 is, for example, fixed to a machine bed 11 as shown in FIG. 8 and a shroud or covering (not shown) is fitted to the shroud support member 6 to enclose a processing station. The shroud support member 6 includes left and right support stands 60. In addition, in the case of the machine tool having a loader for selectively loading and unloading a workpiece onto and from a processing equipment, it is quite often configured such that, as shown in FIG. 8, a travelling rail 22, along which the loader travels, is installed on the shroud support member 6. Regarding the travelling rail 22 for the loader, as shown in FIG. 9, the stands 60 for supporting the travelling rail are installed on a floor surface F in a fashion separated by a distance from the bed 11 and the travelling rail 22 is occasionally supported by those stands 60.

If as shown in FIG. 8, the shroud or covering is fitted to the shroud support member 6 that is fixed to the bed 11, external vibrations may be occasionally transmitted to a processing equipment through the shroud, the shroud support member 6 and the bed 11, thus affecting the processing performed by the processing equipment. In particular, where the machine tool is a multi-axis machine equipped with a plurality of sets of processing equipments, even though the bed 11 on which each set of the processing equipment is installed is separate from each other, vibrations produced during the processing performed by one set of the processing equipment may be transmitted to any other set or sets of processing equipment through the bed 11 and the support member 6 for such set, and the shroud support member 6 and any other set or sets of processing equipment, thus affecting the processing of each of the other set or sets of the equipment. Also, if the travelling rail 22 for the loader is installed on the shroud support member 6, vibrations resulting from the travel of the loader may be transmitted to the processing equipment and, hence, the processing performed by each of the processing equipment may be adversely affected.

Where as shown in FIG. 9 the travelling rail 22 for the loader is supported by the stands 60 that are installed so as to be spaced a distance from the bed 11, no vibration produced by the travel of the loader will be transmitted to the processing equipment. However, in order to install the stands 60 on the floor surface F in a stabilized fashion, an anchor plate 61a for each of the stands 60 provided at a site at which the corresponding stand 60 is fixed to the floor surface F, need be increased in size and, therefore, there arises a problem that the space for installation of the machine tool as a whole tends to increase.

### SUMMARY OF THE INVENTION

In view of the foregoing, preferred embodiments of the present invention provide a machining equipment to which vibrations from inside and outside of the machining equipment will be significantly reduced or prevented from being transmitted to processing equipment.

A machine tool according to a preferred embodiment of the present invention includes a machine bed, a processing machine mounted on the machine bed and configured to perform mechanical processing on a workpiece, a shroud configured to cover a processing station of the processing machine, and a shroud support member configured to support the shroud in a non-contact fashion with respect to the machine bed. According to this construction, since the covering is supported by the covering support member in a non-contact manner relative to the machine bed, vibrations originating from the outside of the machine will not be transmitted to the machine bed through the shroud and the shroud support member and, therefore, the processing performed by the processing machine will not be adversely affected. For this reason, the processing is capable of being executed reliably.

In a preferred embodiment of the present invention, a loader selectively loads and unloads the workpiece relative to the processing machine, the loader is configured to travel along a rail while holding the workpiece, and the shroud support member defines a rail support member to support the rail. Because the shroud support member also defines the rail support member, there is no need to provide any separate or extra rail support member. Thus, it is possible to prevent vibrations of the loader from being transmitted to the processing machine.

In an additional preferred embodiment of the present invention, the shroud preferably includes a box-shaped processing station covering unit configured to enclose the processing station and to define a reinforcement for the shroud support member, and a plate shaped decorative covering unit configured to cover the machine bed and a support unit of the processing machine. In this case, the shroud is configured to cover not only the processing station, but also a machine tool main body as a whole.

In another preferred embodiment of the present invention, the processing machine is provided in a plural number, each of the processing machines is preferably installed on an independent machine bed. If the processing machines are installed on the respective machine beds that are independent from each other, vibrations generated by the processing performed by one processing machine will not be transmitted to any other processing machine through the machine bed and, therefore, the processing performed by any other processing machine will not be adversely affected.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

The above and other elements, features, steps, characteristics and advantages of the present invention will become more apparent from the following detailed description of the preferred embodiments with reference to the attached drawings.

### BRIEF DESCRIPTION OF THE DRAWINGS

In any event, the present invention will become more clearly understood from the following description of preferred embodiments thereof, when taken in conjunction with the accompanying drawings. However, the preferred embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views.

FIG. 1 is a perspective view showing the appearance of a machine tool designed in accordance with a preferred embodiment of the present invention.

FIG. 2 is a perspective view showing of a machine tool according to a preferred embodiment of the present invention with a portion removed.

FIG. 3 is a perspective view showing a machine tool main body of the machine tool according to a preferred embodiment of the present invention.

FIG. 4 is a perspective view showing a processing station covering unit used in the machine tool according to a preferred embodiment of the present invention.

FIG. 5 is a perspective view showing a shroud support member used in the machine tool according to a preferred embodiment of the present invention.

FIG. 6 is a perspective view showing the shroud support member and the processing station covering unit in the machine tool according to a preferred embodiment of the present invention.

FIG. 7 is an explanatory diagram showing one example of a different machine bed installation according to a preferred embodiment of the present invention.

FIG. 8 is a perspective view showing one example of the conventional shroud support members.

FIG. 9 is a perspective view showing one example of the conventional rail support stand assembly.

### DETAILED DESCRIPTION OF THE PREFERRED EMBODIMENTS

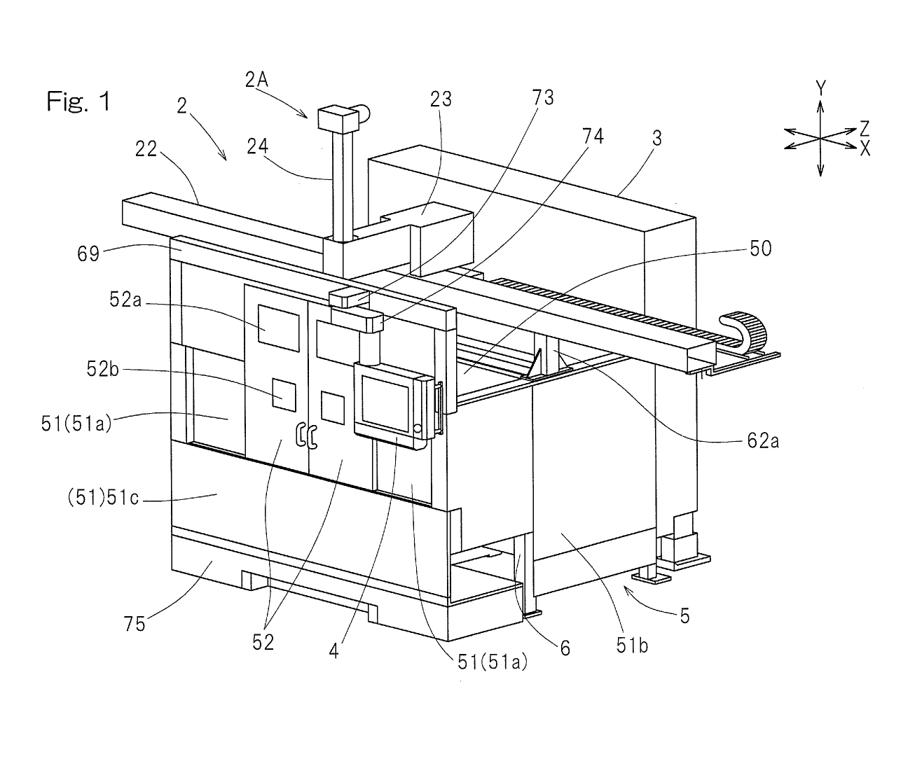

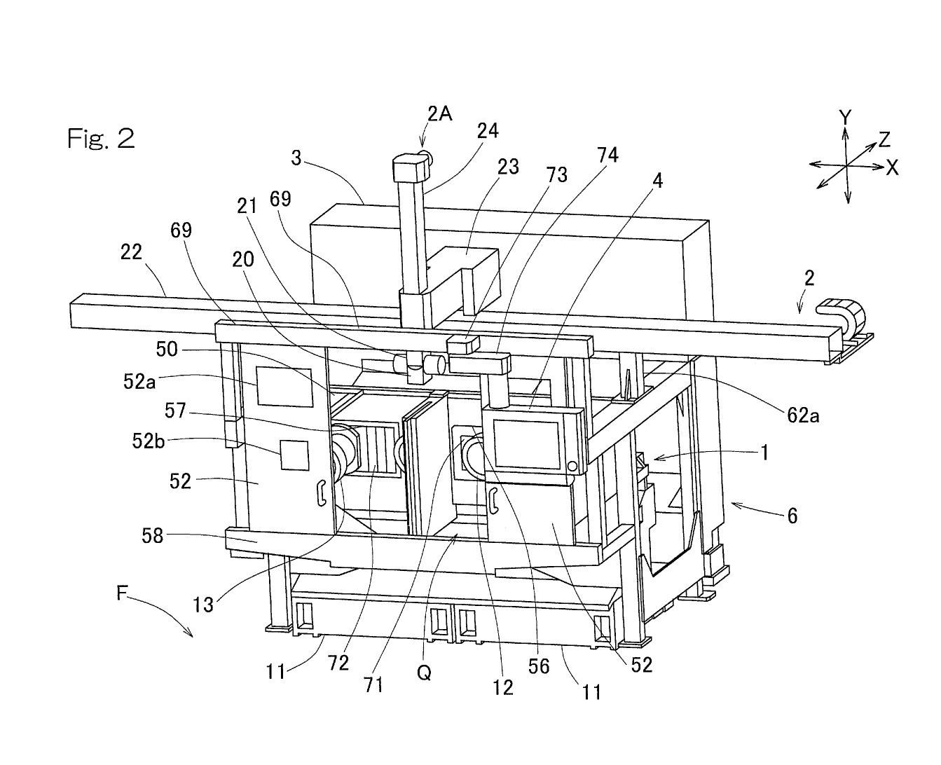

Preferred embodiments of the present invention will now be described in detail with reference to the accompanying drawings. In particular, FIG. 1 illustrates a perspective view showing the appearance of a machine tool and FIG. 2 is a view similar to FIG. 1, but with a portion of the machine tool removed. The machine tool shown in FIGS. 1 and 2 includes a machine tool main body 1, a loader apparatus 2 configured to selectively load and unload a workpiece relative to the machine tool main body 1, a control console 3 configured and programmed to control the machine tool main body 1 and the loader apparatus 2, an operating board 4 configured to operate the machine tool main body 1 and the loader apparatus 2, a shroud or covering assembly 5 configured to enclose the machine tool main body 1, and a shroud support member 6 configured to support the shroud 5. In the instance as shown in FIG. 1, the machine tool main body 1 is covered and hidden by the shroud 5 and is therefore invisible. FIG. 2 illustrates a condition in which a portion of the shroud 5 (a decorative or dress-up covering 51) is removed.

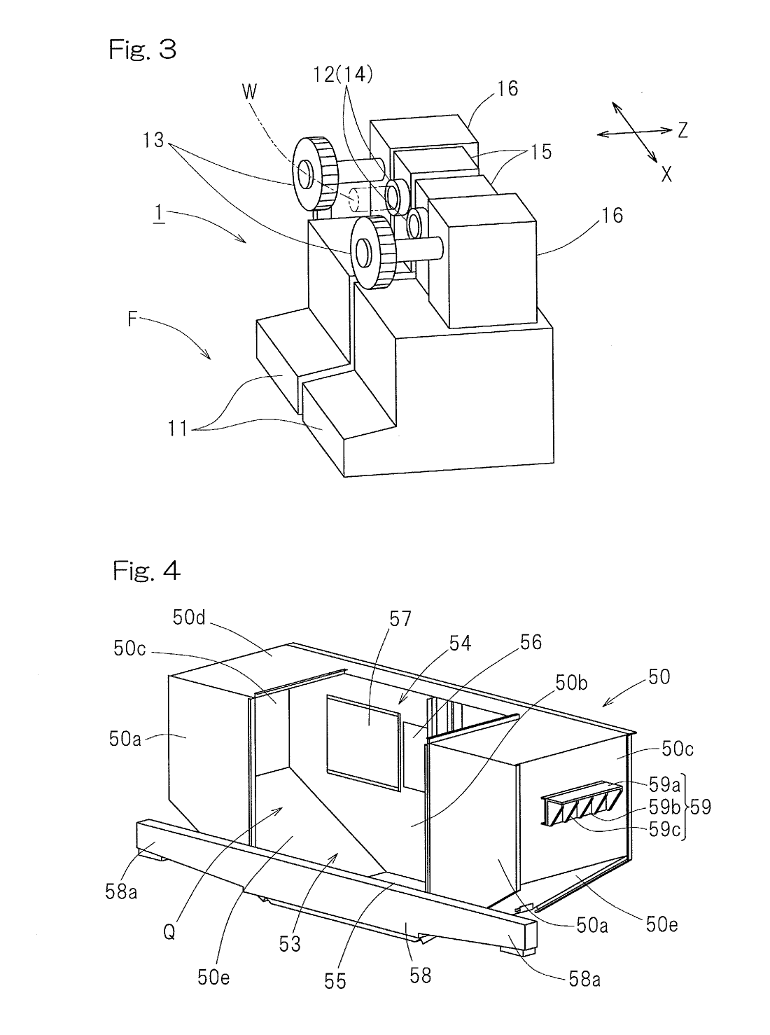

The machine tool main body 1 is best shown in FIG. 3. The machine tool main body 1 of the present preferred embodiment preferably is a parallel double spindle lathe, for example, and includes left and right machine beds 11, installed on a floor surface F in a fashion independent from each other, and each of the machine beds 11 includes a spindle 12 and a tool post 13, both defining constituent elements or components of a processing machine, mounted atop the respective machine bed 11.

The spindle 12 is a shaft extending in an anteroposterior direction (a Z-axis direction) and includes a chuck 14 mounted on a front ends thereof to hold a corresponding work piece. This spindle 12 is rotatably supported by a corresponding headstock 15 mounted on the associated bed 11 and is rotatively driven by a spindle motor (not shown) mounted on the corresponding headstock 15.

The tool post 13 preferably is in the form of a polygonal shaped turret including a plurality of peripheral surfaces altogether defining an outer periphery of the turret. As is well known to those skilled in the art, a plurality of tools (not shown) are adapted to be fitted to the respective peripheral surfaces of the tool post 13 and some or all of the tools are, when the corresponding spindle 12 rotates, selectively indexed to a processing position one at a time. The tool post 13 is supported on a feed slide 16 mounted on the associated machine bed 11 for movement in the anteroposterior direction (Z-axis direction) and also in a bilateral direction (X-axis direction).

The workpiece W then held by the chuck 14 on the respective spindle 12 is processed with the tool then brought into contact with such workpiece during the rotation of each of the spindles 12. With the feed slide 16 moved in the anteroposterior direction, the tool is fed in a direction axially of the corresponding spindle 12 and, with the feed slide 16 moved in the bilateral direction, the depth of cut of the workpiece W by the tool is adjusted.

Referring to FIGS. 1 and 2, the loader apparatus 2 loads the workpiece at a material supply station (not shown) and unloads the workpiece at a product delivery station (also not shown), which stations are defined on left and right sides of the machine tool main body 1, and also loads and unloads the workpiece relative to the spindles 12 of the machine tool main body 1. The loader apparatus 2 shown in the practice of this preferred embodiment preferably is of a gantry type and includes a loader 2A moving on a travelling rail 22, while holding the workpiece, which loader 2A moves in the bilateral direction (X-axis direction) and also in a vertical direction (Y-axis direction) to transport the workpiece. More specifically, the travelling rail 22 is laid above the machine tool main body 1 so as to extend horizontally, and the loader 2A includes a travelling body 23, which is movable along the travelling rail 22, a vertically elongated elevating rod 24 movable up and down relative to the travelling body 23 and a loader head 21, provided at a lower end of the elevating rod 24, to hold the workpiece via a loader chuck 20.

The shroud 5 preferably includes a processing station covering unit 50 configured to enclose a processing station Q, the decorative covering unit 51 and left and right slide doors 52 provided in a front surface portion of the processing station Q. The decorative covering unit 51 encloses the machine bed 11 of the machine tool main body 1, the headstock 15 which is a support unit for the spindle 12, and the feed slide 16 which is a support unit for the tool post 13. The processing station Q is a region where the workpiece is processed by the spindle 12 and the tool post 13, which define constituent elements or components of the processing machine.

The processing station covering unit 50 preferably is, as shown in FIG. 4, of a box-shaped configuration including a front plate segment 50a, a rear plate segment 50b, left and right side plate segments 50c, a top plate segment 50d and a bottom plate segment 50e. Left and right intermediate portions of each of the front plate segment 50a, the top plate segment 50d and the bottom plate segment 50e are cut out to define respective cutout openings. The cutout opening 53 defined in the front plate segment 50a has the slide doors 52 fitted thereto. The cutout opening 54 defined in the top plate segment 50d is an access opening for the loader head 21 of the loader 2A to provide access to and out of the processing station Q. The cutout opening 55 defined in the bottom plate segment 50e is a discharge opening through which scrapes or chips produced as a result of the processing are discharged downwardly and is shaped so as to converge downwardly towards a low level area that occupies a center portion of the bottom plate segment 50e. Also, the rear plate segment 50b is provided with windows 56 and 57 through which the left and right spindles 12 and the left and right tool posts 13 are configured to protrude therethrough into the processing station Q from the rear.

A lower end portion of the front plate segment 50a is provided with a rail member 58 which defines a rail for the slide doors 52. The rail member 58 includes opposite end portions which protrude laterally outwardly beyond the left and right side plate segments 50c and terminate at respective lower to-be-supported portions 58a, which are supported by the shroud support member 6. Also, the left and right side plate segments 50c are provided with respective upper to-be-supported portions 59 each protruding laterally outwardly therefrom and supported by the adjacent shroud support member 6. The upper to-be-supported member 59 preferably has a generally inverted L-shaped configuration having a horizontal portion 59a and a vertical portion 59b, with a plurality of reinforcement ribs 59c provided between the horizontal and vertical portions 59a and 59b. A support structure configured to support the lower and upper to-be-supported portions 58a and 59 via the shroud support members 6 will be described in detail later.

Referring to FIG. 1, the decorative covering unit 51 includes a plurality of plate shaped portions 51a, 51b and 51c fitted to respective portions of the shroud support member 6. The configuration of each of those plate shaped portions 51a to 51c will be described in detail later. The left and right slide doors 52 include respective viewing windows 52a and 52b defined in upper and vertically intermediate portions thereof and made of a transparent material, and are slidably supported by the processing station covering unit 50 and the shroud support member 6. The manner of supporting the slide doors 52 will also be described in detail later.

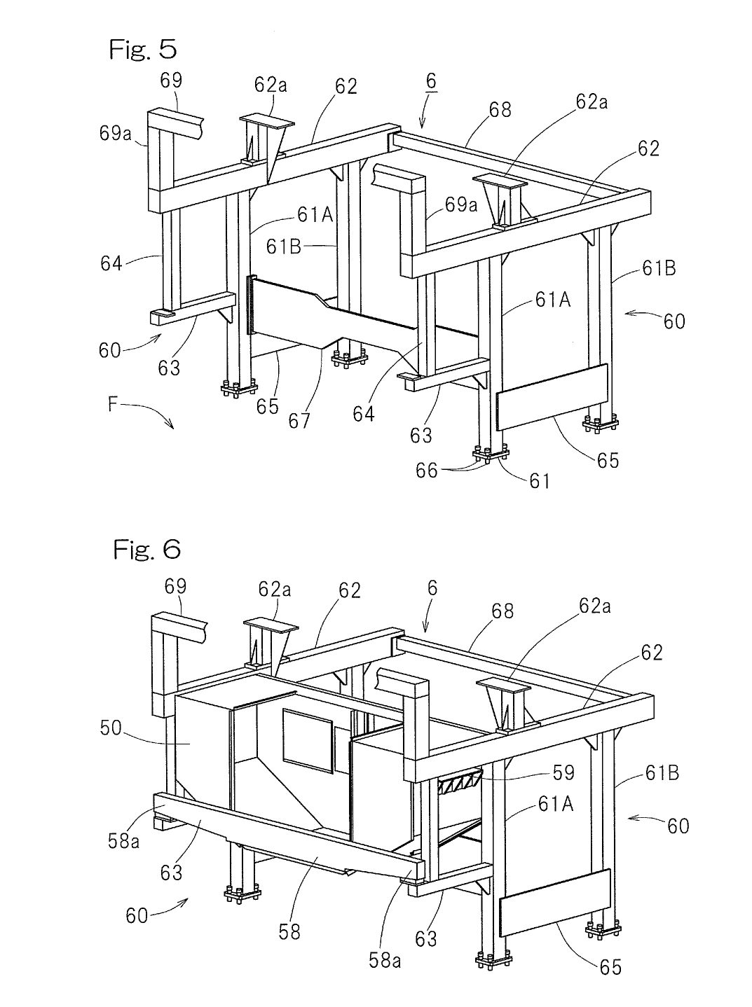

The shroud support member 6 is installed in a non-contact relationship with respect to each of the machine beds 11 of the machine tool main body 1. The shroud support member 6 includes, as shown in FIG. 5, left and right stands 60 that are erected on the floor surface F. Each of the left and right stands 60 includes front and rear support posts 61A and 61B, an upper frame 62 connected with upper ends of the front and rear support posts 61A and 61B so as to extend in the anteroposterior direction, a lower frame 63 protruding forwardly from an intermediate portion of the front support post 61A, a connecting frame 64 connecting the upper frame 62 and the lower frame 63 together, and a first rectangular or substantially rectangular connecting plate 65 of a substantial width connecting lower portions of the front and rear support posts 61A and 61B together with its width lying in the vertical direction. The left and right stands 60 are installed on the floor surface F when respective anchor plates 61, fixed to corresponding lower ends of the support posts 61A and 61B of each of the left and right stands 60, are fixed to the floor surface F via a set bolts 66, for example.

The respective front support posts 61A of the left and right stands 60 are connected together through a second connecting plate 67 of a substantial width and the respective upper frames 62 of the left and right stands 60 are connected together through a control console mounted frame 68 that extends in a bilateral direction. Also, a rail mounting plate 62a configured to support the travelling rail 22 for the loader 2A is provided on the top frame 62 of each of the left and right stands 60. Yet, vertically extending left and right leg members 69a are fixed to respective front ends of the top frames 62 of the left and right stands 60, and a slide door guide frame 69 of a gate shape is provided.

The processing station covering unit 50 is supported by the shroud support member 6 as shown in FIG. 6. In other words, the lower to-be-supported portions 58a, which are left and right ends of the rail member 58, respectively, are preferably located on respective front end portions of the lower frames 63 of the shroud support member 6, and the lower to-be-supported portions 58a and the corresponding lower frames 63 are fixed via, for example, bolts. Also, with the upper to-be-supported member 59 held in contact with a lower surface of the upper frame 62, the upper to-be-supported member 59 and the upper frame 62 are fixed together via, for example, bolts or the like. By so doing, the left and right stands 60 of the shroud support member 6, in addition to the connection between the second connecting plate 67 and the control console mounting frame 68, are connected with each other also by the processing station covering unit 50. The structure, in which the shroud support member 6 and the processing station covering unit 50 are integrated together, has a high rigidity. In other words, the processing station covering unit 50 defines a reinforcement member configured to reinforce the shroud support member 6.

As shown in FIG. 2, the machine tool main body 1 has a configuration such that the machine beds 11 are fixedly installed on the floor surface F with the headstocks 15 (FIG. 3) and the feed slides 16 (FIG. 3) positioned rearwardly of the processing station covering unit 50. Each of the machine beds 11 is arranged to have a non-contact relationship with a structural body including the shroud support member 6 and the processing station covering unit 50. The spindles 12 and the tool posts 13 are exposed to the processing station Q through the adjacent windows 56 and 57. A shielding covering 71 is fixedly fitted to a gap delimited between the window 56, through which the spindles 12 are passed, and the spindles 12. Also, a bellows shaped covering 72, which is configured to undergo a selective expansion or retraction in response to movement of the tool post 13 in a leftward or rightward direction, is fitted to a gap delimited between the window 57, through which the tool post 13 is passed, and the tool post 13.

As best shown in FIGS. 1 and 2, the traveling rail 22 for the loader 2A is installed on the rail mounting plate 62a of the shroud support member 6. The control console 3 is mounted on the control console mounting frame 68 (FIGS. 5 and 6) of the shroud support member 6. Also, the operating board 4 is fitted to a swing fulcrum member 73, provided in the slide door guide frame 69, through a swing arm 78 so that the operating board 4 can be swung about the vertical axis.

As shown in FIG. 1, provided below the processing station covering unit 50 is a chip receiving unit 75 configured to receive the scraps or chips falling downwardly through the opening 55 (FIG. 4) that is defined in the bottom plate segment 50e of the processing station covering unit 50. This chip receiving unit 75 preferably is configured to receive the chips or scrapes, or is a conveyor installed separately from the machine tool so that the chips or scrapes are transported to a chip recovery site.

The decorative covering unit 51 referred to previously includes the plate shaped portions 51a, 51b and 51c fitted to various portions of the shroud support member 6. In other words, on a front side of the front plate segment 50a of the processing station covering unit 50, the front surface plate shaped portion 51a is fitted to the connecting frame 64 and the slide door guide frame 69. The front surface plate shaped portion 51a is not fitted to a front side portion of the opening 53 of the front plate segment 50a, which preferably is configured to be open. The side surface plate shaped portion 51b is fitted to an outer side surface of the left and right stands 60. Between the rear support posts 61b of the left and right stands 60, the rear surface plate shaped portion (not shown) is fitted. Also, on a side upwardly of the chip receiving unit 75, the front surface lower plate shaped part 51c is fitted so as to cover the rail member 58 of the processing station covering unit 50.

The left and right slide doors 52 have their lower ends slidably supported by the rail member 58 of the processing station covering unit 50 for movement in a leftward and rightward direction and also have their upper ends fitted to the slide door guide frame 69 of the shroud support member 6 for movement in the leftward and rightward direction. With the slide doors 52 slid in the leftward and rightward direction, a front surface portion of the processing station Q is configured to be selectively opened and closed.

According to the construction of the machine tool as hereinabove described, since the shroud 5 is supported by the shroud support member 6 which is in a non-contact relation with the machine beds 11 of the machine tool main body 1, vibrations from the outside of the machine will not be transmitted to the machine beds 11 through the shroud 5 and the shroud support member 6. Also, since the traveling rail 22 for the loader 2A is supported by the rail mounting plate 62a of the shroud support member 6, vibrations produced during the travelling of the loader 2A are not transmitted to the machine beds 11. In addition, although the machine tool main body 1 preferably is a parallel double spindle lathe including two sets of processing machines, for example, the machine beds 11, on which the respective processing machines are mounted, are independent from each other, and therefore, vibrations brought about by the processing of one of the processing machines are not transmitted directly to the other of the processing machines. Accordingly, the vibrations inside and outside of the machine will not adversely affect the processing performed by the spindles 12 and the tool posts 13, which define respective constituent elements of the processing machines and, therefore, the processing is reliably accomplished.

In the machine tool of the structure described above, since the shroud support member 6 defines a support member for the travelling rail 22, there is no need to provide any extra support member for the travelling rail 22 and, therefore, the structure is simplified.

In addition, the shroud 5 of the machine tool makes use of, separate from the box-shaped processing station covering unit 50 enclosing the processing station Q and concurrently defining a reinforcement for the shroud support member 6, the plate-shaped decorative covering unit 51 configured to enclose the machine beds 11 as well as the spindles 15 and the feed slide 16, which define support units of the processing machines. Accordingly, both of the processing station Q and the machine tool main body 1 as a whole are covered.

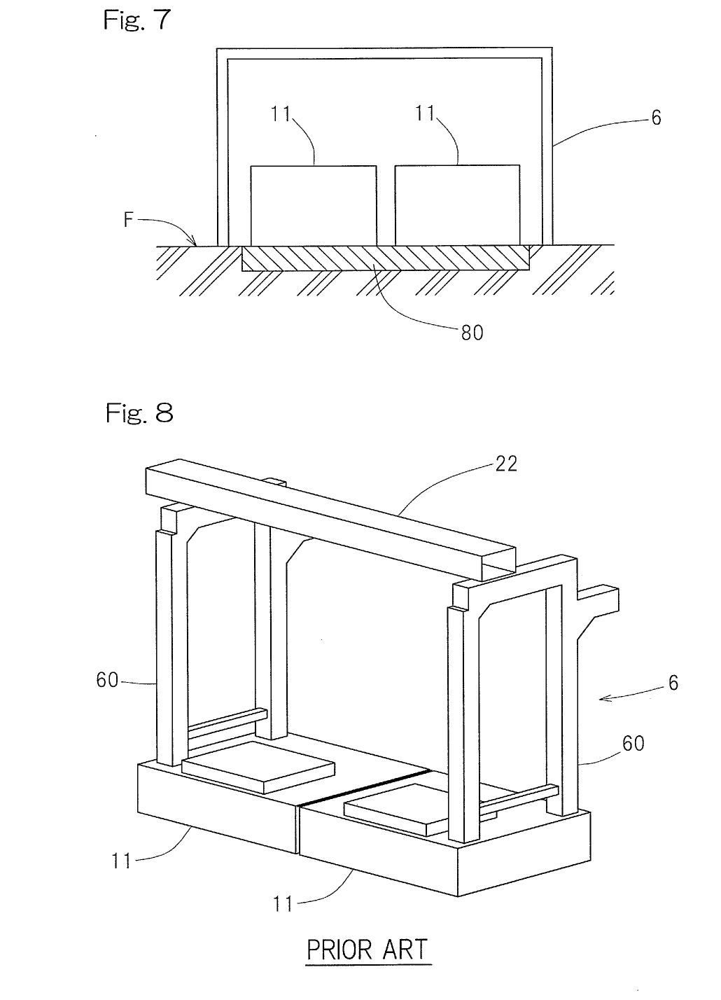

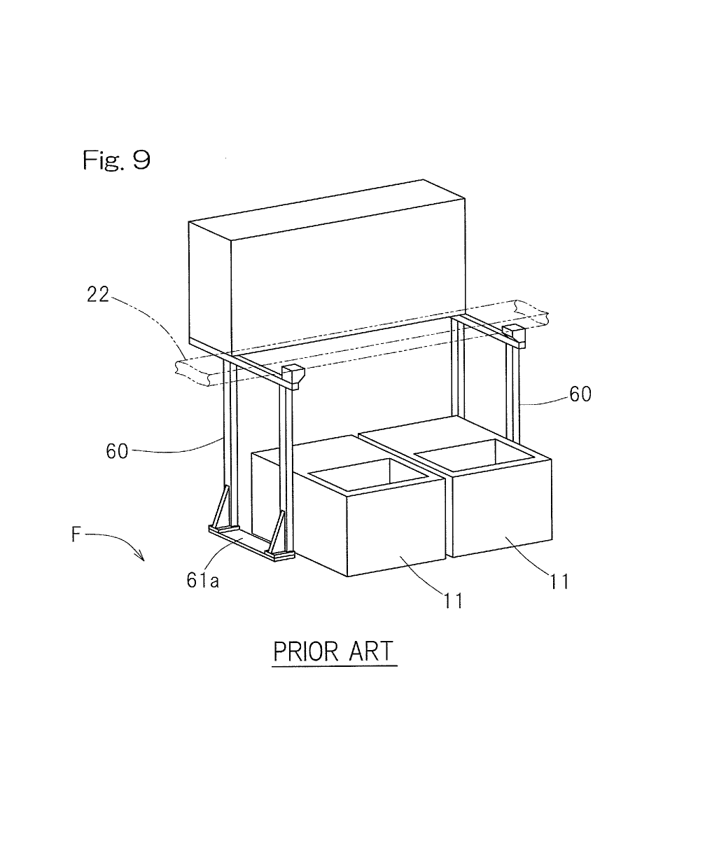

Although the present invention has been fully described in connection with the preferred embodiments thereof with reference to the accompanying drawings which are used only for the purpose of illustration, those skilled in the art will readily conceive numerous changes and modifications that are within the scope of the present invention. By way of example, while in describing the foregoing embodiments, the two machine beds 11 have been shown and described as preferably being installed directly on the floor surface F, such an alternative as shown in FIG. 7 is possible in which a base member 80 is provided on the floor surface F and the machine beds 11 may be installed on the base member 80. Even in this case, the shroud support member 6 is installed in a non-contact relation with respect to the machine beds 11.

In addition, the machine tool main body 1 preferably is not necessarily limited to the double spindle lathe such as shown and described, but may be a three or more spindle lathe, for example. Also, it may be a machine other than the lathe.

Accordingly, such changes and modifications are within the scope of the present invention.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-4. (canceled)

5. A machine tool comprising:
a machine bed;
a processing machine configured to perform mechanical processing on a workpiece mounted on the machine bed;
a shroud configured to cover a processing station of the processing machine;
a shroud support member configured to support the shroud in a non-contact relation with the machine bed; and
a loader configured to selectively load and unload the workpiece relative to the processing machine and configured to travel along a rail while holding the workpiece; wherein
the shroud support member defines a rail support member configured to support the rail.

6. The machine tool as claimed in claim 5, wherein the shroud comprises:
a box-shaped processing station covering unit configured to enclose the processing station and define a reinforcement configured to reinforce the shroud support member; and
a plate-shaped decorative covering unit configured to cover the machine bed and a support unit of the processing machine.

7. The machine tool as claimed in claim 5, wherein the processing machine is provided in a plural number, and each of the processing machines is installed on an independent machine bed.
